(19) United States
(12) Patent Application Publication
(10) Pub. No.: US 2007/0284842 A1
(43) Pub. Date: Dec. 13, 2007

(54) COLLAPSIBLE BICYCLE TRAILER

(75) Inventor: Ryan O'Donnell, Madison, WI (US)

Correspondence Address: GODFREY & KAHN S.C., 780 NORTH WATER STREET, MILWAUKEE, WI, 53202, US

(73) Assignee: Pacific Cycle, LLC.

(21) Appl. No.: 11/423,914

(22) Filed: Jun. 13, 2006

(51) Int. Cl. B62K 27/00

(52) U.S. Cl. 280/204

(57) ABSTRACT

A collapsible bicycle trailer provides a trailer for pulling children with a bicycle which is telescopically collapsible, thus decreasing its footprint and allowing for more compact shipment and storage. The collapsible bicycle trailer also has side rails that fold over so as to lay flat against the chassis and a tow bar that folds inwardly to lie along the chassis. The collapsible bicycle trailer allows for compact and economical shipment and storage and allows for easy and quick assembly.

### FIELD OF THE INVENTION

This invention is generally directed to a bicycle trailer, more specifically a bicycle trailer that has foldable side rails and a collapsible chassis.

### BACKGROUND OF THE INVENTION

In general, bicycle trailers made for pulling children have a unitary frame or chassis with side supports that are attached at the corner of the chassis by fixed connectors. While such bicycle trailers may be broken down for shipment, they generally require assembly by the retailer or by the consumer after purchase. In both cases, the bicycle trailer, once assembled is not easily broken down without disassembling the whole unit. Further, because of the unitary construction of the chassis, when packaged for shipment, the width of the shipping container is dictated by the size of the chassis frame. Therefore, when the packaged bicycle trailers are stored for shipment or sale they require substantial shelf and/or storage space.

For example, U.S. Pat. No. 6,896,275 (the '275 patent) discloses a collapsible bicycle trailer in which the chassis is of unitary construction such that the footprint of the chassis cannot be reduced. The trailer described in the '275 patent has side rails that articulate at their junction with the chassis. Similarly, U.S. Pat. No. 5,020,814 (the '814 patent) discloses a collapsible bicycle trailer in which the chassis is non-adjustable and the side rails fold down over the chassis. Thus, the collapsible trailers described in both the '275 and '814 patents are limited in compactness to the size allowed by the footprint of the chassis and the height of the side rails.

It would be desirable to provide a bicycle trailer that is collapsible at the chassis thereby decreasing the size of the container needed for shipment and foldable at the side rails, thereby increasing the ease of assembly and disassembly.

### SUMMARY OF THE INVENTION

While there are an abundance of bicycle trailer designs for towing small children none provide a chassis that compacts telescopically along its width thereby decreasing the size of the container necessary for its shipment. Further, the bicycle trailer of the present invention may also include collapsible side rails such that the side rails and chassis may be easily assembled by extending the chassis and side rails.

Therefore, in one exemplary embodiment, the present invention includes collapsible bicycle trailer comprising a chassis telescopically adjustable along its width and a pair of foldable side rails. In this embodiment, adjusting the chassis and folding the side rails collapses the bicycle trailer. In additional embodiments the present invention may also include a tow bar, wherein the tow bar is foldably connected to the chassis. In some embodiments, the invention according to this embodiment further includes wheel holders, the wheel holders connected to the chassis at a back bar and rail locks, the rail locks supporting the side rails in the unfolded position.

In some embodiments, the collapsible bicycle trailer has a chassis that is telescopically collapsible along its width and along its length. In this version, when the collapsible bicycle trailer is collapsible along its length, the side rails have hinge-like articulations along their length allowing the side rail to adjust according to the position of the chassis.

In another embodiment, the collapsible bicycle trailer according to this invention includes a chassis having a front bar and a back bar, the front bar and back bar having adjustable lengths and a pair of foldable side rails. In this embodiment, adjusting the lengths of the front bar and back bar and folding the side rails collapses the bicycle trailer. This embodiment of the present invention may also includes a foldable tow bar and/or rail locks

In yet another embodiment, the present invention includes a chassis, the chassis having two parallel side bars with the side bars connected to a parallel front bar and back bar. In addition, the front bar and the back bar comprise two sleeves slidably connected to an insert and by slidably positioning the sleeves outwardly on the insert the length of the front bar and the back bar are increased while slidably positioning the sleeves inwardly on the insert decreases the length of the front bar and back bar. In some embodiments, the invention also includes two side rails, each side rail has a front section, a back section and a top section with the top section foldably connected to the front section and the back section and with the front section and back section foldably connected to the side bars proximate to the front bar and the back bar respectively. In some versions, the collapsible bicycle trailer includes rail locks, the rail locks maintaining the top section in an extended position. Some embodiments may also include a tow bar with the tow bar foldably connected to a side bar. Various embodiments may also include wheel holders attached to each of the side bars proximate to the back bar such that wheels are operably attached to the chassis.

These and other features and advantages of various exemplary embodiments according to the invention are described in, or are apparent from the following detailed description of various preferred embodiments according to this invention. Other alternative embodiments may be described without departing from the invention.

### BRIEF DESCRIPTION OF THE DRAWINGS

Various exemplary embodiments of the present invention will be described in detail, with reference to the following figures, wherein:

FIG. 1 is a front perspective view of one embodiment a folding bicycle trailer frame according to the present invention, partially assembled with the chassis in the expanded position;

FIG. 2 is a front perspective view of the folding bicycle trailer of FIG. 1, with the front and back bars partially collapsed and shown with the tow bar folded inward;

FIG. 3 is a rear perspective view of the folding bicycle trailer of FIG. 1, with the top section of the side rails folded over, the chassis collapsed and shown with the tow bar folded inward;

FIG. 4 is a front view of the folding bicycle trailer of FIG. 1, with the side rails folded and the chassis collapsed;

FIG. 5 is a perspective view of the folding bicycle trailer of FIG. 1, assembled and with wheels attached;

FIG. 6 is a side view of the folding bicycle trailer of FIG. 1, assembled and with wheels attached.

FIG. 7 is a perspective view of another embodiment of the folding bicycle trailer according to the present invention showing the chassis in the expanded position along both the front-to-back axis and the side-to-side axis.

FIG. 8 is a rear perspective view of the folding bicycle trailer of FIG. 7 with the front and back bars, the side bars and the side rails collapsed in the collapsed position.

### DETAILED DESCRIPTION OF THE EXEMPLARY EMBODIMENTS

The following detailed description discloses various exemplary embodiments of a folding bicycle trailer. The trailer according to this invention can be folded and collapsed for packaging and shipment and is easily assembled for use. For storage, the user can easily fold and collapse the trailer so that it can be conveniently stowed until further use. Alternative embodiments consistent with the invention could be designed and manufactured by one of skill in the art.

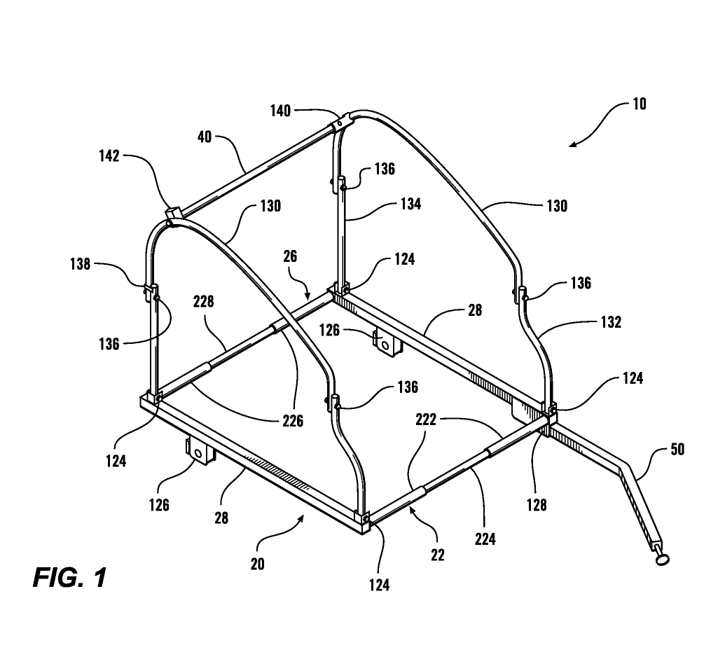

FIG. 1 is a front perspective view of a folding trailer 10 according to this invention. In this view, the trailer 10 is partially assembled but the wheels have not yet been added. As shown, the trailer 10 includes a rectangular chassis 20, having a front bar 22, a back bar 26 and two side bars 28. The front bar 22 has two sleeves 222 slidably connected to a central insert 224. The back bar 26 also has two sleeves 226 slidably connected by a central insert 228. The front bar 22 and the back bar 26 are parallel and opposably connected by the side bars 28 such that when the sleeves 222 and 226 are collapsed the length of the front bar 22 and back bar 26 is reduced by the length of the insert 224 and 228 thus, decreasing the perimeter of the chassis 20.

Also shown in FIG. 1 are two opposing side rails 30. The side rails 30 are foldably connected to each side bar 28 proximal to the front bar 22 and the back bar 26 by hinge-like connectors 124. Each side rail 30 includes a front section 132, a top section 130 and a back section 134. As illustrated, a transverse bar 40 supports the side rails 30 by connecting the opposing side rails 30 at the top section 130. In some preferred embodiments, the transverse bar 40 is connected to one side rail 30 by a hinge-like connector 140 on one side rail 30 and a releasable connector 142 on the other side rail 30 as shown. However, it should be appreciated that the transverse bar 40 can be connected to the side rails 30 by any acceptable connectors such as, for example, a friction clip, cotter pin or the like. Also illustrated are the side rail joints 136 connecting the top section 130 to the front 132 and back 134 sections. As shown in FIG. 1, in one preferred embodiment the connector may be a bolt or pin which allows rotation of the top section along the axis of the connector. FIG. 1 also illustrates the tow bar 50 connected to one of the side bars 28 proximal to the front bar 22 by hinge-like connector 128 and wheel holders 126 located on each side bar 28 proximal to the back bar 26. In the embodiment illustrated in FIG. 1, the wheels (not shown) need only a short shaft or axel to fit into the wheel holder obviating the need for a full axel spanning the chassis.

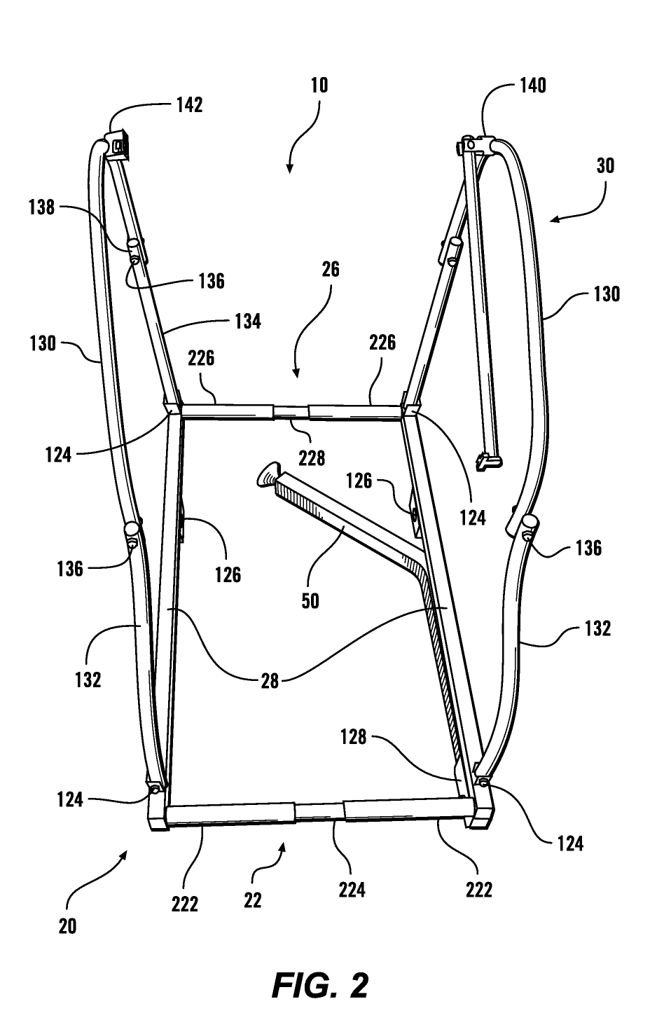

FIG. 2 is a second front perspective view of the folding bicycle trailer 10 shown in FIG. 1, partially collapsed. As shown the tow bar 50 is folded under the chassis 20 at the connector 128. In the embodiment shown in FIGS. 2, 3 and 6 the connector 128 comprises a housing dimensioned and configured to accept the tow bar 50 and retained in place by use of a cotter pin, quick connect clip or the like. Also illustrated in FIG. 2, the transverse bar 40 is detached at one side rail 30 and attached to the other side rail 30 by the hinge-like connector 140.

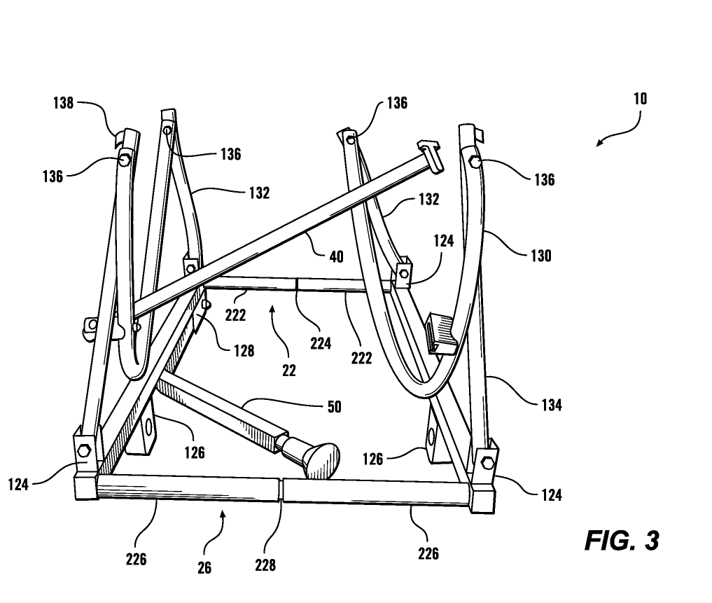

FIG. 3 is a rear perspective view of the folding bicycle trailer 10 of FIG. 1, with the front sleeves 222 and back sleeves 226 collapsed on the inserts 224 and 228. Also shown are the side-rails 30 in which the top sections 130 are folded inwardly against the front and back sections 132 and 134. In this view, also illustrated, is the transverse bar 40 released at one side and folded against the top section 130 and the tow bar 50 folded back against one of the side bars 28 of the chassis 20. Further, proximate to the juncture of the back section 134 and the top section 130 of the side rails 30 are rail locks 138 which reinforce the side rail connectors 136 in the extended position.

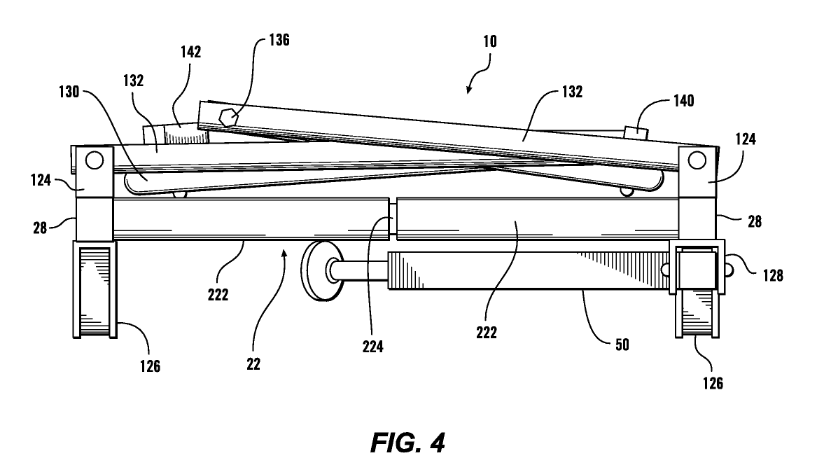

FIG. 4 is a front view of the folding bicycle trailer 10 of FIG. 1 in the collapsed position. As shown, the tow bar 50 is folded underneath the chassis 20 at hinge-like connector 128. Also shown in this view are the side rails 30 folded at connectors 136 and folded over the chassis 20 at connectors 124. Further illustrated is the front bar 22 (back bar 26, not shown in this view) with the sleeves 222 collapsed over the insert 224.

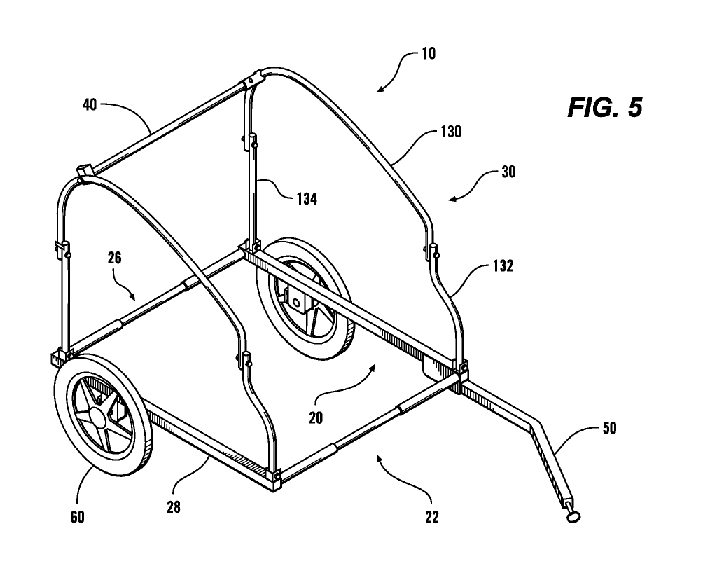

FIG. 5 illustrates the folding bicycle trailer 10 of FIG. 1 fully assembled with wheels 60 attached. In this view, the front and back bars 22, 26 are expanded with the side rails 30 and tow bar 50 extended for use. Also shown is the transverse bar 40 attached to the top sections 130 of the side rails 30 providing extra support for the side rails and rain cover (not shown).

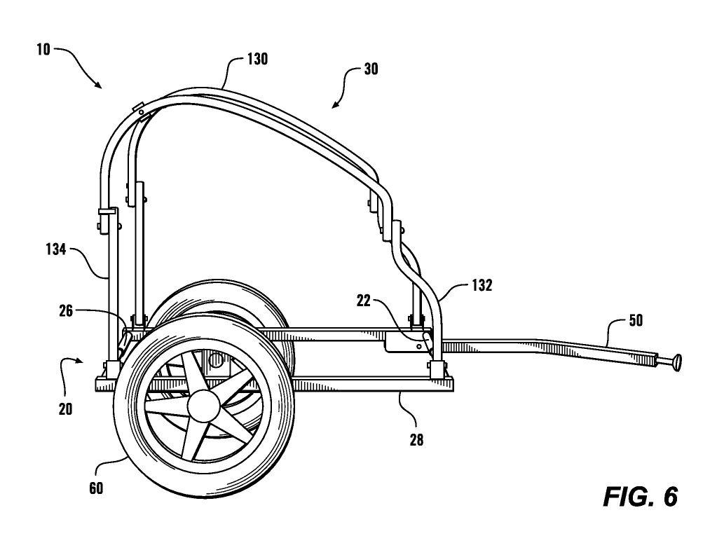

FIG. 6 is a side perspective view of the foldable bicycle trailer 10 of FIG. 1, assembled and ready for the addition of the rain cover.

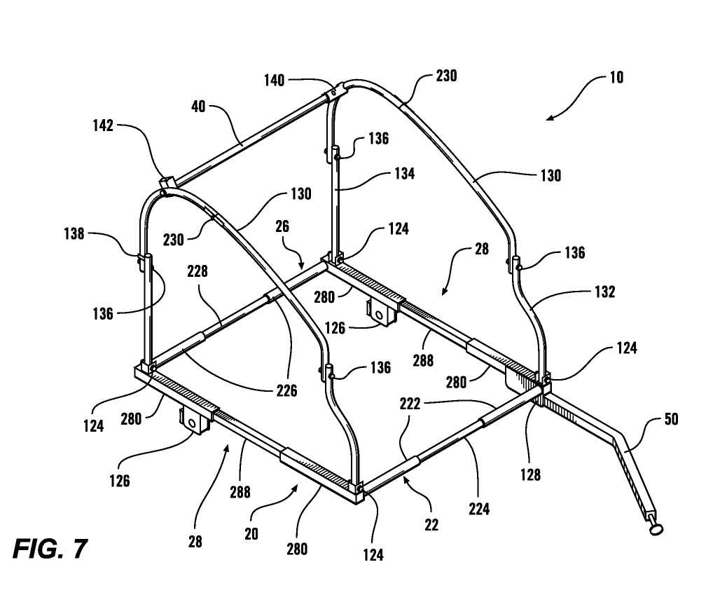

FIG. 7 illustrates another embodiment of the collapsible bicycle trailer according to the invention. In this embodiment, the bicycle trailer 10 is collapsible along its width via the telescopically collapsible front bar 22 and back bar 26 by slidably connected sleeves 222 and 226 along inserts 224 and 228 respectively. Further side bars 28 are telescopically collapsible along side sleeves 280 that are slidably connected via inserts 288 thereby collapsing the chassis 20 along its length. As shown, in this embodiment, the side rails 30 have hinge-like articulations 230 along the top section 130 of the side rail 30. In this fashion, when the chassis 20 is collapsed along its length by slidably moving side sleeves 280 together along insert 288, the side rail 30 folds at hinge 230 thereby allowing the length of side rail to adjust in accordance with the decrease in length of the side bar 28. It should be appreciated that, while the hinge 230 allows the side rail 30 to accommodate the change in length of the side bar 28 the side rail can also be adjusted by any effective articulation. Such as, for example, disconnecting the top section 130 from the front 132 or back 134 section, having a two-part top section 130 connected by use of a sleeve and pin fastener or the like.

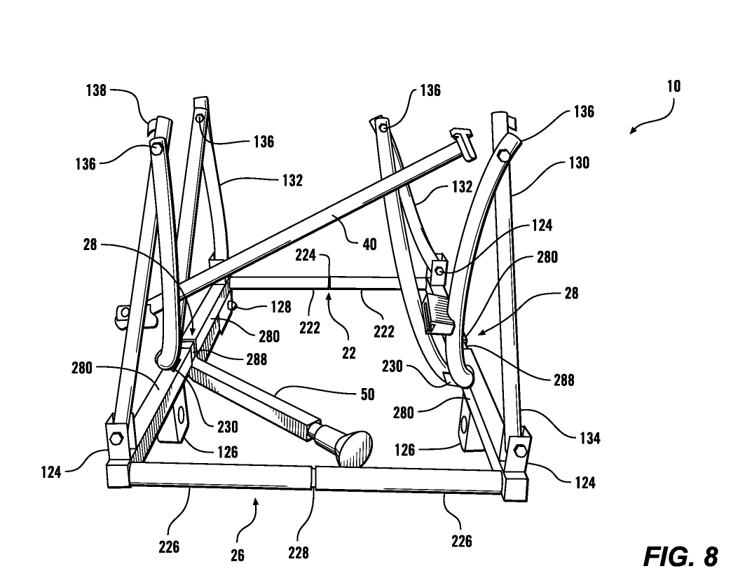

FIG. 8 illustrates the collapsible bicycle trailer of FIG. 7 in a collapsed position with both the front bar 22, back bar 26 and side bars 28 collapsed along inserts 224, 228 and 288 respectively. Also in this view can be seen the side rails 30 collapsed along hinge 230 allowing for the bicycle trailer 10 to be collapsed along more than one dimension.

It should be appreciated that, while various exemplary embodiments of the invention illustrated in the figures show, for example the front and back bar circular in cross-section and side bars rectangular in cross-section it is within the scope of the invention to form the front bar, back bar and side bar in any cross-sectional shape desirable so long as the bar is telescopically collapsible via sleeves along an insert. Similarly, various connecting devices or methods may be used to connect, articulate and/or retain the various elements of the collapsible bicycle trailer in place whether in the collapsed or extended position.

While this invention has been described in conjunction with the various exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments according to this invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents of these exemplary embodiments.

What is claimed is:

1. A collapsible bicycle trailer comprising:
a chassis telescopically adjustable along at least one dimension;
a pair of foldable side rails; and
wherein telescopically adjusting the chassis and folding the side rails collapses the bicycle trailer.

2. The collapsible bicycle trailer of claim 1, further including a tow bar, wherein the tow bar is foldably connected to the chassis.

3. The collapsible bicycle trailer of claim 1, further including wheel holders, the wheel holders connected to the chassis at a back bar.

4. The collapsible bicycle trailer of claim 1, further including rail locks, the rail locks supporting the side rails in the unfolded position.

5. The collapsible bicycle trailer of claim 1, wherein the side rails have a hinge-like articulation.

6. A collapsible bicycle trailer comprising:
a chassis having a front bar and a back bar, the front bar and back bar having adjustable lengths;
a pair of foldable side rails; and
wherein adjusting the lengths of the front bar and back bar and folding the side rails collapses the bicycle trailer.

7. The collapsible bicycle trailer of claim 6, further including a foldable tow bar.

8. The collapsible bicycle trailer of claim 6, further including rail locks.

9. A collapsible bicycle trailer comprising, a chassis, the chassis having two substantially parallel side bars connected to a substantially parallel front bar and back bar, wherein the front bar and the back bar comprise two sleeves slidably connected to an insert and wherein slidably positioning the sleeves outwardly on the insert increases the length of the front bar and the back bar and wherein slidably positioning the sleeves inwardly on the insert decreases the length of the front bar and back bar.

9. The collapsible bicycle trailer of claim 8, further comprising two side rails, wherein each side rail has a front section, a back section and a top section and wherein the top section is foldably connected to the front section and the back section and wherein the front section and back section are foldably connected to the side bars proximate to the front bar and the back bar.

10. The collapsible bicycle trailer of claim 8, further including a tow bar wherein the tow bar is foldably connected to a side bar.

9. The collapsible bicycle trailer of claim 8, further including wheel holders attached to each of the side bars proximate to the back bar wherein wheels are attached at the wheel holders.

10. The collapsible bicycle trailer of claim 8, further including rail locks, the rail locks maintaining the top section in an extended position.
